(19) United States
(12) Patent Application Publication
(10) Pub. No.: US 2005/0159175 A1
(43) Pub. Date: Jul. 21, 2005

(54) Radio remote control transmitted by short message of the mobile telephone system thereof

(76) Inventors: Yingping Zhou, Xuchang City (CN); Huaipo Yang, Xuchang City (CN)

Correspondence Address: Charles E Baxley;Hart Baxley Daniels & Holton, 90 John Street, 3rd Floor, New York, NY, 10038, US

(21) Appl. No.: 10/516,853

(22) PCT Filed: May 27, 2003
(86) PCT No.: PCT/CN03/00396

(30) Foreign Application Priority Data
Jun. 7, 2002 (CN) 02122729.2

(51) Int. Cl. H04Q 7/20

(52) U.S. Cl. 455/466; 455/411

(57) ABSTRACT

The present invention discloses a radio remote control method transmitted by short message of the mobile telephone and system thereof, including: assigning a unique identification code for the radio receiver of a controlled object and establishing a map between the identification code and a mobile phone number; transmitting by the mobile phone the short message containing control command, the short message receiving terminal, according to the map, converting the associated content in the short message into the identification code of radio receiver and instruction code of the controlled object; converting the identification code and the instruction code into radio signals in radio-transmitted format and then transmitting them; reverting the control instruction in the radio signal by the radio receiver having the identification code in its radio signal, and then transmitting it to the control system of the controlled object. The present invention made the radio remote control operation of the mobile telephone toward electric machine, etc., more handiness. With the same remote control function, the factory cost of remote control unit will be lower, and has an extensive popularization vista. At the same time, the running cost of the system will be lower than prior technology, but it will has better reliability.

### TECHNICAL FIELD

The present invention relates to method and system for radio remote control, more particularly, the present invention relates to method and system for radio remote control transmitted by short message of the mobile telephone.

### BACKGROUND OF THE INVENTION

Currently there are mainly three methods for remote control of electric appliances using mobile phones:

1. The Method of Remote Control by Mobile Phone Through Internet

The mobile phone accesses Internet and remotely controls electric appliances through the control units of the networks connected to the electric appliances. This method requires the mobile phone having the function of being capable of accessing the internet, and the controlled terminals must have controlling units being able to identifying remote-controlling commands as well as keeping in connection with the internet. Therefore, the controlling technique is complicated, the cost in operation is high, the remote-control reliability is low and large-scale introduction is difficult.

2. The Method of Remote Control by Mobile Phone Through Dialing

Dialing the telephone controlled units connected to the electric appliance using a mobile phone to remotely control the electric appliance through dual-tone signals. In such a method, it is complicated for the users to operate and unit price is high for the mobile phone in remote control. Remote control of multiple electric appliances is difficult to be achieved in such a method.

3. Method of Remote Control Directly by Short Message of Mobile Phone

Short message is transmitted by a mobile phone to the mobile massage receiving and transmitting unit connected to the electric appliance to achieve the remote control of the electric appliance. Since the remote control is achieved on the basis of the direct transmitting and receiving of short message, the mobile massage receiving and transmitting unit must be supported by a SIM card number and therefore, a large amount of numbers and network sources shall be occupied. Meanwhile, as the mobile massage receiving and transmitting unit has included the major part of a mobile phone, the cost is high.

### BRIEF DESCRIPTION OF THE INVENTION

The objective of the present invention is to provide a method and system for radio remote control transmitted by short message of the mobile telephone that is easy in operation and low in cost.

The present invention includes the steps of:
Assigning a unique identification code for the radio receiver of a controlled object and establishing a map between the identification code and a telephone number;
Transmitting by the mobile phone the short message containing control command, the short message receiving terminal, according to the map, converting the associated content in the short message into the identification code of radio receiver and instruction code of the controlled object;
Converting the identification code and the instruction code by the short message receiving terminal into radio signals in radio-transmitted format and then transmitting them;
Reverting the control instruction in the radio signal by the radio receiver having the identification code in its radio signal and then transmitting it to the control system of the controlled object.

The system of the present invention includes:
A terminal capable of transmitting short messages, short message receiving terminal, signaling converting unit, coding processing unit, signaling transmitting platform and controlled object;
The controlled object has a radio receiver and a control system, wherein the radio receiver is assigned a unique identification code and a map is established between the identification code and a mobile phone number;
The short message receiving terminal receives a short message containing control commands transmitted by a mobile phone and conveys the short message to the signaling converting unit, then the signaling converting unit, according to the map, converts the relevant contents in the short message into the identification code of the radio receiver and the instruction code of the controlled object; the coding processing unit converts the identification code and instruction code into radio signals in radio-transmitted format and transmits them via the signaling transmitting platform; the radio receiver reverts the control instruction in the radio signal and transmits it to the control system of the controlled object.

The advantages of the present invention:

1. Since the control information consists of mobile phone number and short message, and the mobile number is unique and cannot be simulated, the controlled electric appliance is also unique and can be operated exactly without the need of setting a password.

2. Since the technique of information converting and coding and re-transmitting is utilized, the radio receiving unit does not need the support of a SIM card number and does not occupy number and network sources in achieving equivalent remote control function. Meanwhile, the cost of manufacture of the receiving unit is reduced to the minimum, so it is convenient for the large-scale spread and use.

3. Since the operation of remote control is achieved through short message of mobile phone, it is easy for the users to operate and grasp the method of operation.

### BRIEF DESCRIPTION OF THE DRAWINGS

FIG. 1 is a schematic diagram of the system proposed in the present invention;

FIG. 2 is a schematic diagram of the system proposed in the present invention in actual network circumference;

FIG. 3 is a schematic diagram of an embodiment of the present invention taking an air conditioner as the controlled object;

FIG. 4 is a schematic diagram of an embodiment of the present invention which is a remote controller of a universal air conditioner;

FIG. 5 is a schematic view of principle;

FIG. 6 is a schematic diagram of an embodiment of the present invention which is an intelligent short message remote control socket;

FIG. 7 is a schematic diagram of an embodiment of the present invention which is a solution for guard against theft of automobiles and management of group vehicles;

FIG. 8 is a schematic view of principle.

### DETAILED DESCRIPTION OF PREFERRED EMBODIMENTS

The preferred embodiments of the present invention shall be described hereinafter with reference to the drawings.

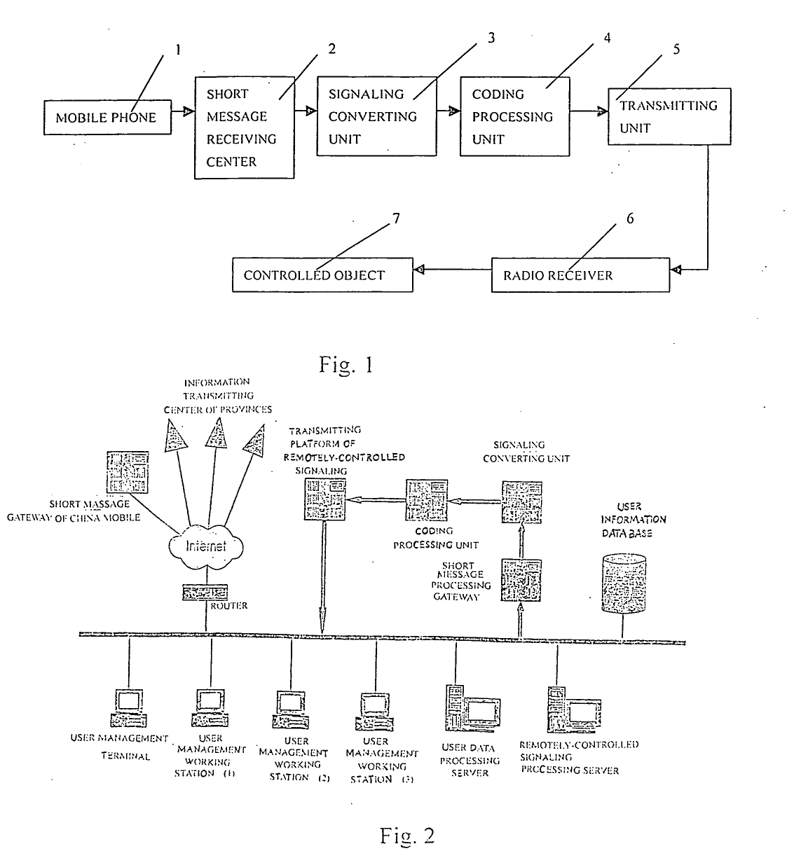

Reference is made now to FIG. 1 illustrating that the system proposed in the present invention includes a mobile phone terminal 1 capable of transmitting short message, a short message receiving center 2, a signaling converting unit 3, a coding processing unit 4, a signaling transmitting platform 5 and a controlled object 7, wherein the controlled object 7 has a radio receiver 6 and a control system, the radio receiver 6 is used for receiving radio signals and may be a control device with a receiving principle similar to that of a radio pager; the radio receiver 6 has a unique identification code and can have a signal path with the control system of the controlled object 7. For the present invention, before remote control via the short message service (SMS) of the mobile phone, a correspondence, namely, a map, must be established between the number of the mobile phone and the radio receiver 6 of the controlled object 7. Such a map can be registered either through transmitting a short message by the mobile phone to the designated registration location, or through networks. The present embodiment is to establish a one-one mapping between the number of the mobile phone, the name of the controlled object and the identification code of the radio receiver.

The short message receiving center 2 receives from the mobile phone 1 the short message containing control command and then conveys the short message to the signaling converting unit 3, the signaling converting unit 3, according to the map, converts the relevant contents in the short message into the identification code of the radio receiver 6 and the instruction code of the controlled object, the coding processing unit 4 converts the identification code and the instruction code into radio signals in radio-transmitted format and transmits them via the signaling transmitting platform 5, the radio receiver reverts the control instruction in the radio signals and transmit it to the control system of the controlled object 7.

The control flow of the method proposed in the present invention can be seen from FIG. 1:

Transmitting a short message containing control instruction using a mobile phone to the short message receiving center of the short message terminal, taking the mobile phone number and the control information from the received short message and conveys into the signaling converting unit 3, the signaling converting unit 3, according to the established map, converts the mobile phone number and the control information into the identification code of the radio receiver of the controlled object and the instruction code of the controlled object, the converted identification code and the instruction code enters the coding processing unit 4 where the instruction code is converted into radio signals in radio-transmitted format, such as FLEX format or POCSAG format; then the instruction code is conveyed into the signaling transmitting platform 5 which modulates the coded information into radio signals and then transmits them. The radio receiver 6 of the controlled object 7 demodulates the radio signals and gets the identification code and the instruction code from the radio signals; then the radio receiver 6 compares the identification code and the instruction code it got with the identification code of itself, if they are identical, the radio receiver 6 shall transmit the instruction code to the control system of the controlled object. The transmission of the control instruction from the radio receiver 6 to the controlled object 7 may be in the form of radio, such as the form of infrared remote control, and may also be in the form of wire connection.

Sometimes, keeping secret shall be concerned in the information transmitted using the technical solution of the present invention, for example, when the method of remote control is utilized to recharge a metering mechanism, the information recharged must be treated in a way of keeping secret strictly in order to prevent the information being deciphered during transmission. In such cases, the information to be transmitted needs ciphering. Therefore, in the information transmission achieved in signaling converting units and radio transceivers, the information shall be ciphered to increase the security of the system. The ciphering and deciphering technologies are universal in prior art and shall be described herein.

From the technical view of remote control using short message, it can be used in hundreds of fields in industrial production and the life of people, while from the view of the market demands, the use of remote control using short message is most potential in home appliances and guard against theft of automobiles. The preferred embodiments of the present invention described below shall be focused on these two fields.

### Embodiment 1

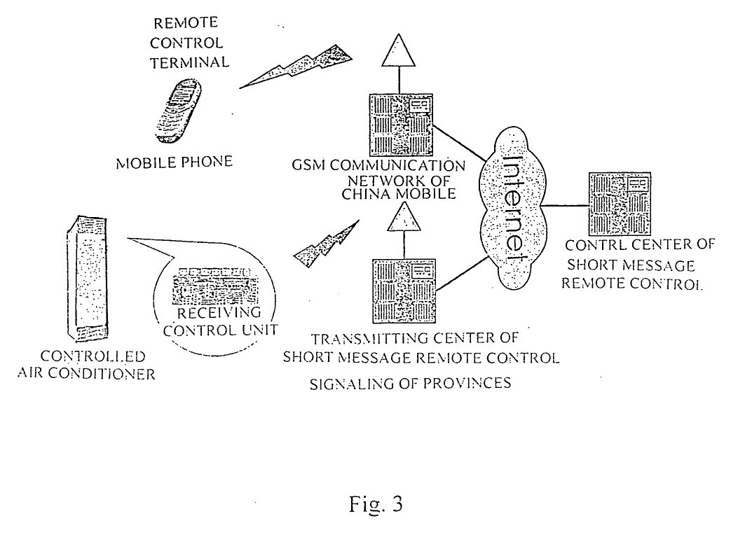

As shown in FIG. 2, the controlled object is an air conditioner and the radio receiver is a controlling device with the principle similar to that of a radio pager or radio remote control receiving module with a one-chip control. The radio remote control module may be mounted inside the air conditioner and the output of the pager in connected to the control system of the air conditioner through wires.

The mobile phone with the number of 12345678910 transmits a short message to start the air conditioner of which the address code of the radio pager is 0123400. Before use, the mobile phone transmits a short message of “Air Conditioner A-0123400” to the registration location of short message (short message receiving terminal) which may provided by the manufacturer of the air conditioner. After the transmission of the short message succeeds, at the short message receiving terminal, a map shall be established between the identification 0123400 of the radio pager and the number of 12345678910 of the mobile phone. When the short message of “Air Conditioner A starts” is transmitted by the mobile phone (the number of the location for receiving the short message may be a special one), the receiving center 2 of the short message receiving terminal takes out the number of “12345678910” of the mobile phone and the short message of “Air Conditioner A starts”; the signaling converting unit 3, according to the map established, converts the number of “12345678910” of the mobile phone into the address code of “012340” of the radio pager, and the short message of “Air Conditioner A starts” into control information of “001100”, and then converts the address code of “0123400” and the control information of “001100” into control instruction information of “Q0123400D001100”; the coding processing unit converts the control instruction information into the form of POCSAG; the transmitting unit 5 modulates the control instruction information in the form of POCSAG into radio wave and transmits. The radio pager of the Air Conditioner A receives the radio wave, demodulates from the radio wave the address code of “0123400” and compares it with the address code of itself. If the address codes are the same, the radio pager of the Air Conditioner A shall convert the control instruction of “001100” into the signal of starting the air conditioner and then transmits the signal to the control system of the air conditioner to control the starting of the air conditioner.

The system proposed in the present invention allows the simpler and more convenient operation of the control of electric appliances using a mobile phone. The system may achieve the same remote control functions as the prior art may while the cost of manufacture of the control units is lower, so it is perspective in large-scale spreading. Meanwhile, the cost of operation is lower than that in the prior art and the reliability is higher.

### Embodiment 2

In this embodiment, the control unit is embedded in the inside of an air conditioner or an electric water heater. As shown in FIG. 3, the control unit is installed in an air conditioner or an electric water heater. No auxiliary is needed and no appearance is affected in achieving the control of the switch of the air conditioner or the electric water heater through short message of a mobile phone. In this embodiment, the cost is the lowest and the reliability is the highest, so it is the main method for remotely controlling home appliances. The principle in achieving such a method is the same as that of the embodiment 1 and similar designs may be performed.

### Embodiment 3

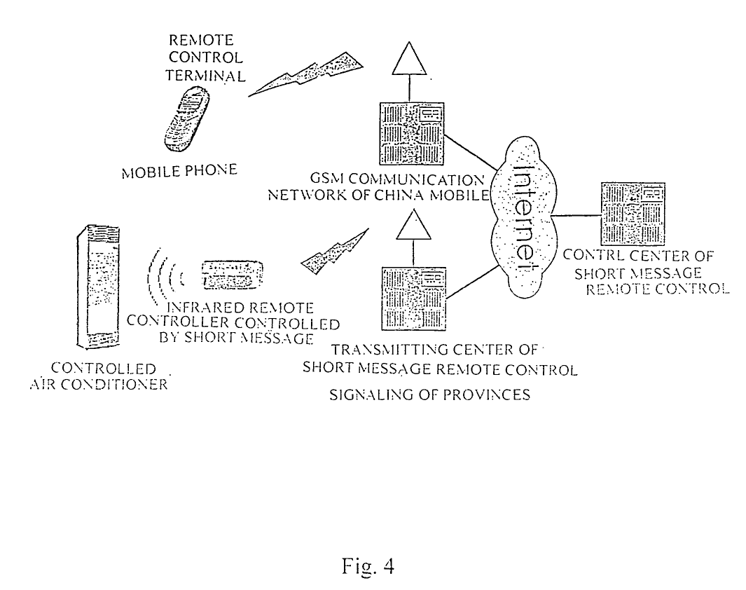

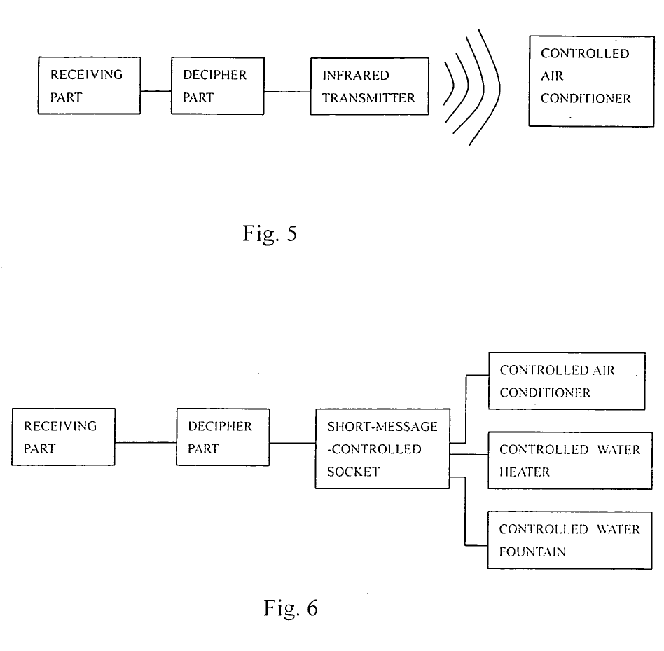

The controlled object in the present embodiment is a universal remote controller of air conditioner. As shown in FIG. 4, the embodiment is a short-message-controlled infrared universal remote controller where short-distance infrared remote control and long-distance short message remote control functions are integrated. The short-distance infrared remote controller has a self-learning function and may remotely control from a long distance any type of infrared and remote-controlled electric appliance. The remote controller consists of a receiving part, a deciphering part and an infrared transmitting device and may remotely control through short message of a mobile phone any electric appliance and apparatus having infrared receiving device. The principle of the remote controller is shown in FIG. 5 and is identical to that of the embodiment 1 and similar designs may be performed.

### Embodiment 4

The controlled object is an intelligence short-message-controlled socket. As shown in FIG. 6, the “Handheld Treasure” short-message-controlled socket is a multi-functional socket having the function of long-distance short message control. It may be used to remotely control various hone appliances, such as electric water heaters, water fountains, electric cookers, microwave stoves and air conditioners (without infrared remote control function). The control of the electric appliances is achieved through the connection and disconnection of the controlled socket. The principle in achieving such a method is the same as that of the embodiment 1 and similar designs may be performed.

### Embodiment 5

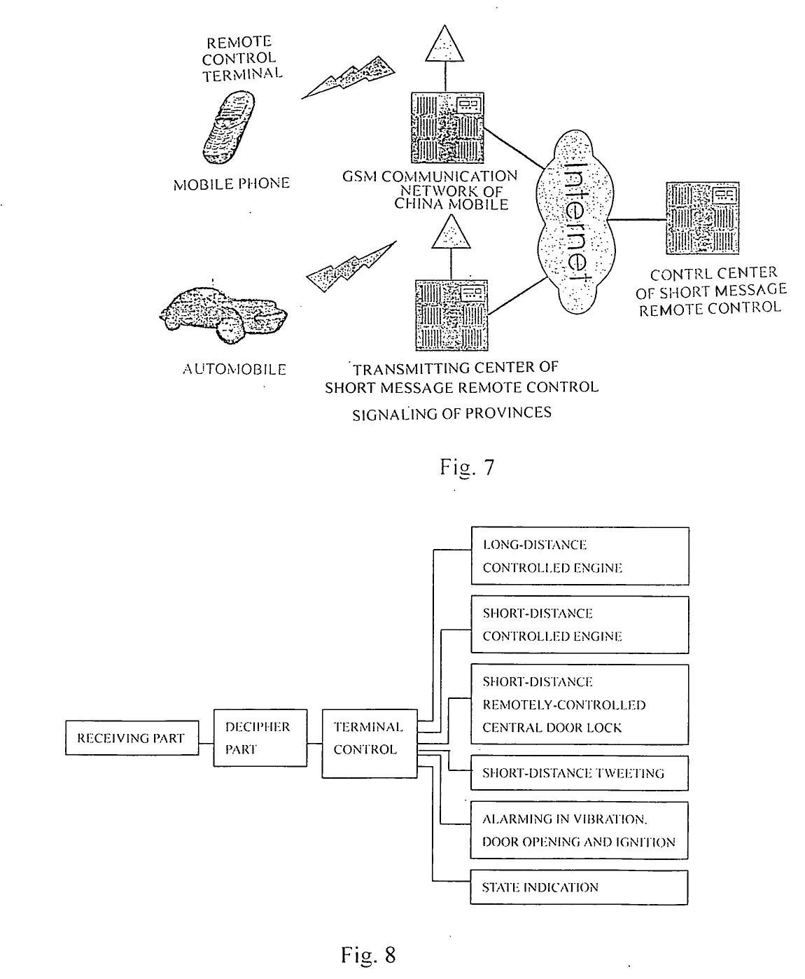

As shown in FIG. 7, the present embodiment is a solution for guard against theft of automobiles and management of group vehicles. Is can used for: 1. remote control of air conditioners; 2. guard against theft and robbery of automobiles; 3. provision of remedies for the users after the lost of automobiles; 4. management of automobiles, such as monitoring and control of collective automobiles to reduce accidents and unnecessary waste; 5. short-distance monitoring of automobiles, such as alarming the drivers when the automobiles are hit or the automobiles are ignited while the doors are open.

The system for the remote control of the air conditioner and the device for guard against theft of an automobile mainly includes a receiving part, a decoding part, a terminal controlling part and a short-distance auxiliary remote control receiving part. The principle in achieving such a system is the same as that of the embodiment 1 and similar designs may be performed.

### Embodiment 6

This is a solution for the remote control of management of payment of fees of water, electric power and gas, as shown in FIG. 8. The principle is that transmitting a short message by a mobile phone containing instructions for fees payment, for example, the short message coding of payment of fee of electric power is “JFD” and the amount of payment is RMB 100. Transmitting the short message of “JFD100” to the remotely-controlled terminal No. 9821, the short message containing the instructions on the payment and the number of the mobile phone shall be processed and the fees shall be calculated automatically in the mobile short message platform, meanwhile, the short message shall be transmitted to the short message processing center and charge management data processing center and shall be converted automatically into data information that can be identified by the radio receiver installed in the ammeter and shall be transmitted via the transmitting station. After the payment data information is received by the radio receiver installed in the ammeter, the counting memory in the ammeter shall automatically increase the corresponding amount of electric power. Thus, the operation of automatic payment of electric power through short message of a mobile phone is completed. The same principle may be used in the management of payment of fees of water and gas. Reliable ciphering data processing is needed in the payment information in the system.

The system may achieve the same remote control functions as the prior art may while the cost of manufacture of the control units is lower, so it is perspective in large-scale spreading. Meanwhile, the cost of operation is lower than that in the prior art and the reliability is higher.

While the invention has been particularly shown and described with reference to the preferred embodiments, it will be understood by those skilled in the art that they are not meant to be limiting and any changes or modifications are covered in the scope of the present invention. Therefore, the scope of the invention shall be defined by the claims that follow.

1. A method for remote control using short message of a mobile phone, wherein, the method includes the steps of:
assigning a unique identification code for the radio receiver of a controlled object and establishing a map between the identification code and a mobile phone number;
transmitting by the mobile phone the short message containing control command, the short message receiving terminal, according to the map, converting the associated content in the short message into the identification code of radio receiver and instruction code of the controlled object;
converting the identification code and the instruction code into radio signals in radio-transmitted format and then transmitting them;
reverting the control instruction in the radio signal by the radio receiver having the identification code in its radio signal, and then transmitting it to the control system of the controlled object.

2. The method according to claim 1, wherein, the radio receiver may be a control device with a receiving principle similar to that of a radio pager, and the identification code is the address code of the radio pager.

3. The method according to claim 1. wherein, a registration short message containing the name of the controlled object and the identification code is transmitted by the mobile phone, and the short message receiving terminal establishes a one-one mapping between the number of the mobile phone, the name of the controlled object and the identification code of the radio receiver.

4. The method according to claim 3, wherein, the name of the controlled object may adopt a name in Chinese or unified coding.

5. The method according to claim 1, wherein, the converting of the content of the short message by the short message receiving terminal includes the steps of: 1) taking the mobile phone number, the name of the controlled object and the control command from the short message; 2) finding the identification code of the radio receiver of the controlled object from the mapping according to the number of the mobile phone and the name of the controlled object, and converting the control command into the instruction code of the controlled object.

6. The method according to claim 1, wherein, the identification code and the instruction code are converted into radio-transmitted protocol format through coding processing and are modulated into radio signals.

7. The method according to claim 1, wherein, the radio-transmitted protocol format is FLEX, POCSAG or other formats.

8. The method according to claim 6, wherein, the radio-transmitted protocol format is FLEX, POCSAG or other formats.

9. The method according to claim 1, wherein, before converting the control instruction in the radio signals, the radio receiver includes: demodulating the radio signals, and getting the identification code and the instruction code from the radio signals; then comparing the identification code and the instruction code it got with the identification code of itself, if they are identical, the radio receiver shall transmit the instruction code to the control system of the controlled object.

10. The method according to claim 1, wherein, further includes the steps of ciphering and deciphering the transmitted information.

11. The method according to claim 6, wherein, further includes the steps of ciphering and deciphering the transmitted information.

12. The method according to claim 10, wherein, the steps of ciphering and deciphering are achieved by a signaling converting unit and a radio transceiver.

13. The method according to claim 11, wherein, the steps of ciphering and deciphering are achieved by a signaling converting unit and a radio transceiver.

14. The method according to claim 1, wherein, the transmission of the control instruction from the radio receiver to the control system of the controlled object may be in the form of radio and may also be in the form of wire connection.

15. A system for remote control using short message of a mobile phone, wherein, the system includes:
a terminal capable of transmitting short messages, a short message receiving terminal, a signaling converting unit, a coding processing unit, a signaling transmitting platform and a controlled object;
the controlled object has a radio receiver and a control system, wherein the radio receiver is assigned a unique identification code and a map is established between the identification code and a mobile phone number;
the short message receiving terminal receives a short message containing control commands transmitted by a mobile phone and conveys the short message to the signaling converting unit, then the signaling converting unit, according to the map, converts the relevant contents in the short message into the identification code of the radio receiver and the instruction code of the controlled object; the coding processing unit converts the identification code and instruction code into radio signals in radio-transmitted format and transmits them via the signaling transmitting platform; the radio receiver reverts the control instruction in the radio signal and transmits it to the control system of the controlled object.

16. The system according to claim 15, wherein, the radio receiver may be a control device with a receiving principle similar to that of a radio pager, and the identification code is the address code of the radio pager.

17. The system according to claim 15, wherein, the radio-transmitted protocol format is FLEX, POCSAG or other formats.

18. The system according to claim 15, wherein, the transmission of the control instruction from the radio receiver to the control system of the controlled object may be in the form of radio and may also be in the form of wire connection.

19. The system according to claim 15, wherein, the controlled object may be home appliances, the system of guard against theft or the system of charging of automobiles.
